(19) United States
(12) Patent Application Publication
(10) Pub. No.: US 2026/0188297 A1
(43) Pub. Date: Jul. 2, 2026

(54) Realistic Lip Synchronization for Artificial Intelligence-Powered Talking Avatars

(71) Applicant: 2hr Learning, Inc., Austin, TX (US)

(72) Inventors: Tiago de Gaspari, Venice, CA (US); Andrew Wiskus, Mound, MN (US)

(73) Assignee: 2hr Learning, Inc., Austin, TX (US)

(21) Appl. No.: 19/438,599

(22) Filed: Jan. 1, 2026

Related U.S. Application Data
(60) Provisional application No. 63/741,023, filed on Jan. 1, 2025.

(51) Int. Cl. G10L 13/08; G06T 13/40

(52) U.S. Cl. CPC G10L 13/08; G06T 13/40

(57) ABSTRACT

The system and method for generating realistic lip synchronization for an AI avatar. The lip synchronization process begins by receiving input data. The input data can either be text input or audio stream. If the input data is text input, a text-to-speech (TTS) module converts it into speech while generating word-level timestamps. If the input data is the audio stream, an automatic speech recognition (ASR) module transcribes the spoken content and provides word-level timestamps. The transcribed text is transformed into a sequence of phonemes using a grapheme-to-phoneme conversion system. The phonemes are mapped to visemes based on their corresponding mouth shapes using a predefined phoneme to viseme mapping table. Then the visemes are mapped to the blendshapes of the AI avatar using image similarity comparison. The selected blendshapes are animated to generate synchronized animation of the AI avatar, with transitions smoothed to ensure natural lip movements and facial expressions.

### CROSS-REFERENCE TO RELATED APPLICATION(S)

This application claims the benefit under 35 U.S.C. § 119 (e) and 37 C.F.R. § 1.78 of U.S. Provisional Application No. 63/741,023, which is incorporated by reference in its entirety.

### FIELD OF THE INVENTION

The present invention relates in general to the field of electronics, and more specifically to realistic lip synchronization for artificial intelligence-powered talking avatars.

### DESCRIPTION OF THE RELATED ART

Avatar creation and lip-syncing technologies are revolutionizing the way we interact with digital content. The avatar creation and lip-syncing technologies allow users to create realistic and expressive digital characters that can speak and emote, making interactions with them more engaging and immersive. The avatar creation involves designing and developing digital characters that can represent real people or fictional entities. These avatars can be 2D or 3D, and they can range from simple cartoon characters to highly realistic human-like figures. However, traditional avatar creation and lip-syncing technologies often struggle to integrate effectively with modern text-to-speech (TTS) systems, resulting in several key limitations. The traditional avatar creation and lip-syncing technologies rely on pre-recorded animations or simplistic mapping techniques that don't adapt well to the diverse outputs of TTS systems. This leads to a mismatch between the audio and visual components, especially when different voices or speaking styles are used in the avatars. This limitation restricts the ability to personalize avatar voices or switch between different speaking styles, severely limiting the versatility of the avatars.

Many traditional avatar creation and lip-syncing technologies are computationally intensive or rely on large databases of pre-animated sequences. This results in slower processing times, making them unsuitable for real-time applications or scenarios requiring quick responses. The traditional avatar creation and lip-syncing technologies often produce stiff, unrealistic mouth movements that don't accurately reflect the nuances of human speech. This is particularly noticeable when dealing with different languages or accents, where subtle variations in pronunciation can significantly affect lip movements. This makes the traditional avatar creation and lip-syncing technologies to create truly multilingual or adaptable avatars. These limitations collectively result in avatar animations that appear unnatural and lack personalization. The disconnect between audio output and visual representation diminishes the overall quality, limiting effectiveness in various applications from educational tools to virtual customer service representatives.

Earlier attempts to address lip synchronization for the avatars have fallen short in several key areas. Some traditional avatar creation and lip-syncing technologies relied on extensive libraries of pre-animated mouth movements. While providing decent quality for specific phrases, this method lacked flexibility. It couldn't easily adapt to new or dynamically generated speech, limiting real-time applications and voice personalization. Moreover, rule-based systems are used which utilize a set of predefined rules to determine lip movements based on input provided by the user. However, the rule-based systems are unable to capture the complexity of natural speech, especially when dealing with different accents or languages. They also struggled to keep up with the evolving capabilities of the TTS systems. Furthermore, direct audio analysis is used to generate lip movements by directly analyzing the audio waveform. These systems often produced low-quality results, especially with synthesized speech. They are also computationally intensive, causing performance issues in real-time applications. Additionally, manual animation techniques are also implemented to generate high-quality results. The manual animation techniques are required to animate the lip movements manually. However, the manual techniques are extremely time-consuming and not scalable for dynamic or real-time speech generation.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary lip synchronization system to generate realistic lip synchronization for an AI avatar.

FIG. 2 depicts an exemplary lip synchronization process utilized by the lip synchronization system.

FIG. 3 depicts a realistic animation process for the AI avatar, which is an embodiment of the lip synchronization process of FIG. 2.

FIG. 4 depicts the sequence diagram for generating the animated AI avatar, which is an embodiment of the lip synchronization process of FIG. 2.

FIG. 5 depict exemplary representation showing viseme visual representations and respective images of the AI avatar.

FIG. 6 depicts an exemplary network environment in which the system of FIG. 1 and the process of FIG. 2 may be practiced.

FIG. 7 depicts an exemplary computer system.

### DETAILED DESCRIPTION

The system and method for generating realistic lip synchronization for an AI avatar. The lip synchronization process begins by receiving input data. The input data can either be text input or audio stream. If the input data is text input, a text-to-speech (TTS) module converts it into speech while generating word-level timestamps. If the input data is the audio stream, an automatic speech recognition (ASR) module transcribes the spoken content and provides word-level timestamps. The transcribed text is transformed into a sequence of phonemes using a grapheme-to-phoneme conversion system. The phonemes are mapped to visemes based on their corresponding mouth shapes using a predefined phoneme to viseme mapping table. Then the visemes are mapped to the blendshapes of the AI avatar using image similarity comparison. The selected blendshapes are animated to generate synchronized animation of the AI avatar, with transitions smoothed to ensure natural lip movements and facial expressions.

Additionally, the lip synchronization process includes multiple voice options in the TTS module. Also, the ASR module of the lip synchronization process supports multi-language. The grapheme-to-phoneme conversion system employs a rule-based, index-preserving transformation technique that ensures accurate extraction of phonemes from the transcribed text. The viseme-to-blendshape mapping employs a machine learning algorithm for improved accuracy. Moreover, the Interpolation techniques are utilized to enhance the animation's smoothness. Furthermore, the users can customize the smoothing levels of the AI avatar by using a Savitzky-Golay filter. The lip synchronization process also supports real-time processing, providing minimal latency for live interactions.

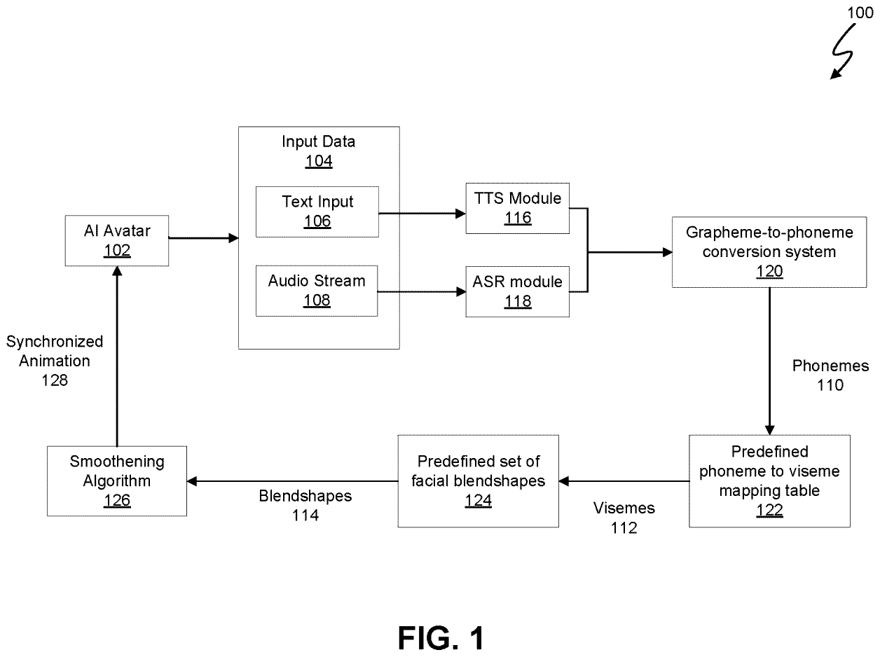

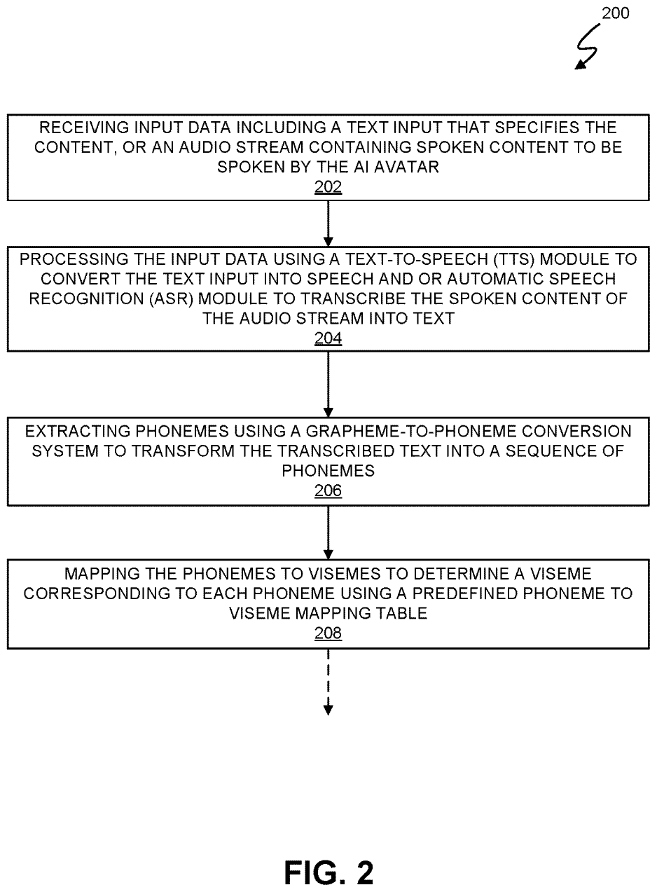

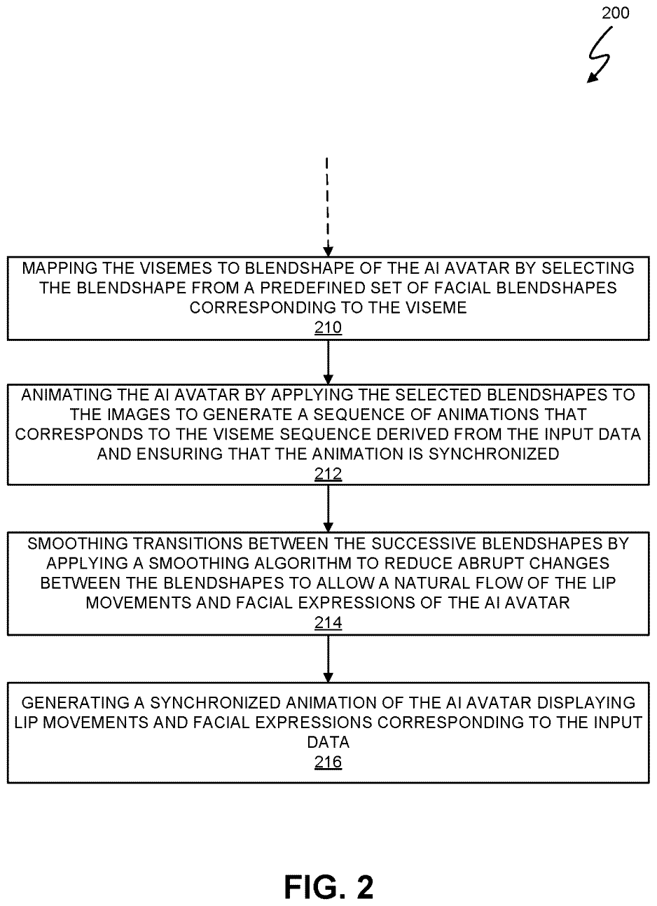

FIG. 1 depicts an exemplary lip synchronization system 100 to generate realistic lip synchronization for an AI avatar 102. FIG. 2 depicts an exemplary lip synchronization process 200 utilized by the lip synchronization system 100.

The lip synchronization process 200 ensures the lip movements of the AI avatar 102 correspond to an input data 104 to provide a realistic conversation between a user and the AI avatar 102. The input data 104 includes a text input 106 and audio stream 108 which is analyzed to determine phonemes 110. The determined phonemes 110 are used to identify a suitable visemes 112. The visemes 112 identified are used to generate blendshape(s) 114 for the AI avatar 102. The lip synchronization process 200 ensures the creation of a natural and engaging user experience in applications like virtual assistants, online learning platforms, gaming, and interactive media.

Referring to FIGS. 1 and 2, in operation 202, receiving the input data 104. The input data 104 includes the text input 106 that specifies the content, or the audio stream 108 containing spoken content to be spoken by the AI avatar 102. The input data 104 is a message or an output that the AI avatar 102 wants to convey during the conversation with the user. The input data 104 can be the text input 106 or the audio stream 108. When the input data 104 is provided as the text input 106, it specifies the content that the AI avatar 102 will articulate. The text input 106 is particularly effective for scenarios where precision is crucial, as written text eliminates ambiguities in pronunciation or phrasing. For example, the user might input a script, instructions, or a query in written form, allowing the AI avatar 102 to process it directly and produce a spoken output to create a seamless and engaging experience. In this regard, the user can be an end-user, or a person who is having a conversation with AI avatar 102. In at least one embodiment, the user can be a student, teacher or any person having conversation with the AI avatar 102.

Alternatively, the input data 104 can be provided as the audio stream 108, which contains spoken content. The audio stream 108 is provided when the user prefers or needs to communicate verbally. For example, audio stream 108 can be directly provided by the user by speaking directly into a microphone or a pre-recorded audio file. Beneficially, the dual input such as text input 106 or the audio stream 108 allows the user to type the query or speak the query. If the user chooses to type, the text input 106 specifies the content, which the AI avatar 102 processes and responds to vocally, ensuring clarity and accessibility. On the other hand, if the user opts to speak, the audio stream 108 is captured, transcribed, and analyzed to extract the intended message. The AI avatar 102 then conveys the response in a natural and engaging manner, fostering effective communication. In at least one embodiment, the lip synchronization system 100 could analyze the tone and sentiment of the spoken input, enabling the AI avatar 102 to respond with appropriate emotional expressions.

In operation 204, processing the input data 104. If the input data 104 includes the text input 106, using a text-to-speech (TTS) module 116 to convert the text input 106 into speech and generate word-level timestamps corresponding to the pronunciation of each word of the text input 106.

When the input data 104 is in the form of the text input 106, the TTS module 116 is used to process it. The TTS module 116 is configured to transform written text such as text input 106 into natural-sounding speech. The TTS module 116 analyzes the textual content provided by the user by parsing the text to understand its structure, meaning, and pronunciation. In at least one embodiment, the TTS module 116 incorporates a combination of linguistic algorithms, phonetic analysis, and prosody modeling to transform the text input 106 into the speech. Moreover, the TTS module 116 produces word-level timestamps. The word-level timestamps serve as markers, indicating the precise moment each word is pronounced within the speech. The word-level timestamps enable the synchronization of each word. The word-level timestamps ensure that the visual or textual elements align perfectly with the audio of the AI avatar 102. This alignment enhances the overall user experience by creating a cohesive and immersive interaction. For example, the text input 106 such as, “The sun rises in the east.” The TTS module 116 processes this sentence, converts it into spoken audio, and generates word-level timestamps like the following:
“The”—0.2 seconds
“sun”—0.5 seconds
“rises”—0.9 seconds
“in”—1.2 seconds
“the”—1.4 seconds
“east”—1.6 seconds

The TTS module 116 provides multiple voice and speech style options, including pitch, speed, tone, and accent. The pitch enables the voice to sound higher or lower; speed allows the speech to be faster or slower to match the desired pacing; and tone can be modified to convey specific emotions such as enthusiasm, seriousness, or calmness. The TTS module 116 supports a variety of accents ensuring that the speech output can reflect regional or cultural nuances, enhancing relatability and authenticity.

Moreover, if the input data 104 includes the audio stream 108, applying an automatic speech recognition (ASR) module 118 to transcribe the spoken content of the audio stream 108 into text and generate word-level timestamps indicating when each word occurs within the audio stream 108.

The ASR module 118 converts spoken language such as the audio stream 108 into written text. The ASR module 118 captures the audio stream 108, which may consist of live speech of the user or pre-recorded content. The ASR module 118 analyzes the audio stream 118 and transcribes the spoken content. The transcription generated by the ASR module 118 is accompanied by word-level timestamps, which indicate the exact time each word occurs within the audio stream 108. The word-level timestamps allow to quickly locate specific portions of the audio based on the corresponding text.

For example, the audio stream 108 provided by the user contains the sentence “Artificial intelligence is transforming industries worldwide.” The transcription provides an accurate textual representation of the audio stream 108 and enables efficient navigation between the audio stream 108. Below is the example of the transcription output of the audio stream 108 with word-level timestamps:
“Artificial”—0.3 seconds
“intelligence”—0.8 seconds
“is”—1.5 seconds
“transforming”—1.8 seconds
“industries”—2.4 seconds
“worldwide”—3.0 seconds

In at least one embodiment, the ASR module 118 utilizes contextual analysis to leverage domain-specific language models tailored to particular fields, such as educational, legal, medical, or technical. This ensures accuracy in recognizing and transcribing specialized terminology.

The audio stream 108 processed through the ASR module 118 supports multi-language transcription to dynamically select the appropriate language based on the characteristics of the AI avatar 102. The multi-language transcription allows the ASR module 118 to seamlessly identify and transcribe spoken content in multiple languages without requiring user intervention. The ASR module 118 evaluates the audio stream 108 to determine the appropriate language for transcription. The adaptability of ASR module 118 ensures that the AI avatar 102 can respond accurately and effectively, regardless of the language being spoken, making interactions fluid and inclusive. For example, if the AI avatar 102 is designed to operate in a bilingual customer support role, the ASR module 118 can automatically detect whether the audio stream 108 is in English or Spanish and transcribe it accordingly. Both the TTS module 116 and the ASR module 118 ensure the lip synchronization system 100 handles diverse input data 104 effectively.

In operation 206, extracting the phonemes 110 using a grapheme-to-phoneme conversion system 120 to transform the transcribed text into the sequence of phonemes 110. The grapheme-to-phoneme conversion system 120 preserves the indexing of the phonemes 110 relative to their positions within the input data 104. The phonemes 110 are the smallest sound units in speech and are the building blocks of spoken language, and their correct identification is essential for creating natural speech outputs for the AI avatar 102. The grapheme-to-phoneme conversion system 120 acts as an intermediary that translates graphemes into their corresponding phonemes 110. The grapheme-to-phoneme conversion system 120 involves using linguistic algorithms capable of interpreting the rules and patterns of pronunciation for a given language. For example, the grapheme “c” can correspond to different phonemes, such as/k/in “cat” or/s/in “cease,” depending on its context. The grapheme-to-phoneme conversion system 120 accurately resolves such ambiguities by analyzing the surrounding graphemes and applying phonological rules. Furthermore, the grapheme-to-phoneme conversion system 120 preserves the indexing of the phonemes 110 relative to their positions within the input data 104, ensuring that the phonetic sequence remains aligned with the text.

When the speech is received, which could be provided by the transcription from the ASR module 118 or through TTS module 116, the grapheme-to-phoneme conversion system 120 applies phonological rules to extract the sequence of the phoneme 110 that reflects the pronunciation of the words. For example, the sentence “The cat sat on the mat” would be transformed into the phonemes 110 sequence like this:
“The”→/∂ [symbol] /
“cat”→/k→t/
“sat”→/s→t/
“on”→/νn/
“the”→/∂ [symbol] /
“mat”→/mæt/

Each phoneme 110 is assigned an index corresponding to its position in the original text. The indexing ensures that the relationship between the graphemes and phonemes 110 remains intact. The phonemes 110 indexing is essential for ensuring that every sound corresponds accurately to its position. The grapheme-to-phoneme conversion system 120 enables precise timing of phonetic outputs, ensuring that the lip movements of the AI avatar 102 align seamlessly with the input data 104.

The grapheme-to-phoneme conversion system 120 employs a rule-based, index-preserving transformation technique that ensures accurate extraction of phonemes 110 for complex text inputs, including numerical values, abbreviations, and special symbols. The grapheme-to-phoneme conversion system 120 approach leverages rule-based, index-preserving transformation technique to ensure that the pronunciation of such challenging text elements is precise and contextually appropriate. For example, numerical values like “2024” are transformed into the phonemes 110 corresponding to their spoken form, such as/twεnti ‘foυr/, depending on the context. Similarly, abbreviations like “NASA” are automatically converted into their expanded phonetic form, while maintaining the correct sequence and alignment with the text input 106. The special symbols, such as “&” (ampersand), are mapped to their corresponding spoken equivalents (/ænd/), ensuring smooth pronunciation.

In operation 208, mapping the phonemes 110 to visemes 112 to determine a viseme 112 corresponding to each phoneme 110 using a predefined phoneme to viseme mapping table 122. The phonemes 110 share similar mouth shapes and are assigned to the same viseme 112. Typically, identifying the phonemes 110 in the speech through the grapheme-to-phoneme conversion system 120. Once the phonemes 110 are identified, they are mapped to their corresponding visemes 112 using the predefined phoneme-to-viseme mapping table 122. The predefined phoneme-to-viseme mapping table 122 serves as a reference that associates each phoneme 110 with the specific viseme 112 that represents its visual articulation. For example, the phonemes 110 like /p/, /b/, and /m/ share a similar bilabial mouth shape (where both lips come together) and are therefore assigned to the same viseme 112. Similarly, phonemes 110 like /k/, /g/, and /ng/, which involve the tongue touching the back of the roof of the mouth, correspond to another viseme 112. The predefined phoneme-to-viseme mapping table 122 simplifies the mapping process, as it reduces the number of unique visemes 112 that need to be modeled while maintaining an accurate representation of speech.

Moreover, mapping the phonemes 110 to the visemes 112 synchronizes audio and visual elements of speech for the AI avatar 102. The mapping of the phonemes 110 to the visemes 112 ensures that the movement of the mouth, lips, and jaw aligns with the input data 104 to create a more natural and believable interaction. This alignment enhances the realism of the animation and also improves comprehension. The predefined phoneme-to-viseme mapping table 122 is designed based on extensive studies of phonetics and articulation, ensuring that the visemes 112 accurately represent the phonemes 110 they correspond to. The predefined phoneme-to-viseme mapping table 122 is not static but can be customized or enhanced based on the requirements of the application or the linguistic context. For example, the predefined phoneme-to-viseme mapping table 122 designed for American English might differ slightly from British English or other languages. When the AI avatar 102 speaks, its visual speech movements must align with the generated audio to create a seamless user experience. If the AI avatar 102 need to say, “Welcome” firstly the text is converted into phonemes 110 like /w/, /E/, /l/, /k/, /A/, /m/. Each phoneme is then mapped to its corresponding viseme 112 using the predefined phoneme-to-viseme mapping table 122. Such as:
/w/→Rounded lips (viseme for “w”)
/c/→Slightly open mouth (viseme for “e”)
/l/→Tongue touching upper teeth (viseme for “l”)
/m/→Closed lips (viseme for “m”)

As the AI avatar 102 speaks, its facial animations follow this sequence of visemes 112, ensuring that the lip movements accurately match the sounds being produced. This synchronization makes the AI avatar 102 appear more lifelike and engaging, enhancing the effectiveness of its communication.

In operation 210, mapping the visemes 112 to blendshape 114 of the AI avatar 102 by selecting the blendshape 114 from a predefined set of facial blendshapes 124 corresponding to the viseme 112. The selection of the blendshape 114 is based on an image similarity comparison between the visual reference of the viseme representing the mouth shape of a human associated with the same phoneme 110 and associating each viseme 112 with the blendshape 114 that exhibits the closest visual similarity to the image of the AI avatar 102. The AI avatar 102 is equipped with the predefined set of facial blendshapes 124, each representing a distinct configuration of facial features. The blendshapes 114 are designed to capture a wide range of expressions and mouth shapes, such as closed lips, open lips, rounded lips, or tongue positioning. The predefined set of facial blendshapes 124 serves as the foundation for mapping visemes 112 to the appropriate facial movements. For each phoneme 110 in the speech, a corresponding viseme 112 is identified, representing the human mouth shape associated with that phoneme 110. These visemes 112 are visual references, often derived from studies of human articulation, which capture the essential characteristics of how the mouth appears when producing specific sounds.

The lip synchronization process 200 performs the image similarity comparison to match each viseme 112 with the visually similar blendshape 114 to the image of the AI avatar 102. This involves analyzing the visual features of the viseme 112, such as the position of the lips, openness of the mouth, and overall shape, and comparing them to the corresponding features of the blendshapes 114. In at least one embodiment, advanced image processing techniques or machine learning algorithms may be employed to quantify the similarity and select the best match. Once the visually similar blendshape 114 is identified, it is associated with the viseme 112. This mapping ensures that whenever the viseme 112 is triggered during speech synthesis, the corresponding blendshape 114 is activated, causing the AI avatar 102 to produce the appropriate mouth movement.

The mapping of the visemes 112 to the blendshapes 114 utilizes a machine learning algorithm that is trained on a dataset of human facial expressions to improve the accuracy of the viseme 112 to the blendshape 114 associations. The machine learning algorithm analyzes the intricate details of how human faces move and adapt when forming specific mouth shapes corresponding to various phonemes 110. By leveraging the patterns learned from the dataset, it allows to identify subtle nuances in lip, jaw, and tongue movements, ensuring that the selected blendshape 114 closely mirrors the intended viseme 112. This data-driven approach allows the machine learning algorithm to account for variations in articulation across different speakers, accents, and expressions, making the mapping process robust and versatile.

In at least one embodiment, a plurality of neural networks may be utilized for mapping visemes 112 to blendshapes 114. The plurality of neural networks can be trained on large datasets of human speech and corresponding facial movements. The plurality of neural networks learns to predict the optimal blendshape 114 for each viseme 112 based on contextual information and visual features. For example, the plurality of neural networks might consider not only the current viseme 112 but also the preceding and following visemes 112 to ensure smooth transitions between blendshapes 114, resulting in fluid and natural animations of the AI avatar 102.

In operation 212, animating the AI avatar 102 by applying the selected blendshapes 114 to the images of the AI avatar 102 to generate a sequence of animations that corresponds to the viseme 112 sequence derived from the input data 104 and ensuring that the animation is synchronized. The sequence of the visemes 112 is derived from the input data 104, which could be the text input 106 or audio stream 108. Each viseme 112 in the sequence corresponds to a specific blendshape 114, selected based on the mapping process. For example, if the AI avatar 102 is pronouncing the word “hello,” the phonemes 110 would be /h/, /ε/, /l/, and /oν/ and are converted into their respective visemes 112. These visemes 112 are then matched with the blendshapes 114 from the predefined set of facial blendshapes 124 that captures the facial configurations needed to visually represent each sound. By applying these blendshapes 114 to successive frames of the images of the AI avatar 102, to generate a sequence of animations that simulate the natural movement of the human face during speech.

Typically, the animation is synchronized with the audio stream 108 or text input 106 by timing each blendshape 114 to match the word-level timestamps. For instance, if the audio stream 108 duration of the /h/ sound in “hello” is 0.2 seconds, the blendshape 114 corresponding to the /h/ viseme 112 will be applied for that duration before transitioning to the blendshape 114 for /a/. Animating the AI avatar 102 with synchronized blendshapes 114 enhances the realism of the communication. The accurate animation of the mouth movements of the AI avatar 102 ensures that the user can visually track the speech, improving comprehension and engagement. For example, when the AI avatar 102 says “thank you,” the transition from the viseme 112 for /θ/ (tongue between the teeth) to /æ/ (open mouth with spread lips) and then to /ηk/ (closed back of the mouth) mirrors natural human articulation.

The interpolating between the consecutive blendshapes 114 is done by using an interpolation technique to enhance the smoothness of animations during speech transitions. Each viseme 112 is associated with a keyframe that specifies the start and end times for the corresponding blendshape 114. Interpolation between these keyframes creates smooth transitions, eliminating abrupt changes that might disrupt the animation's flow. The interpolation technique calculates intermediate frames between the consecutive blendshapes 114, allowing for a gradual transition that mimics the fluidity of human facial movements. For example, when the AI avatar 102 transitions from the /m/ sound (closed lips) to the /a/ sound (wide-open mouth), interpolation generates incremental changes in the mouth's shape, avoiding abrupt or mechanical shifts. By leveraging the interpolation technique, the visual gaps or jerks are eliminated in the animation, maintaining a seamless flow that enhances the overall experience and immersion.

In operation 214, smoothing transitions between the successive blendshapes 114 by applying a smoothing algorithm 126 to reduce abrupt changes between the blendshapes to allow a natural flow of the lip movements and facial expressions of the AI avatar 102. Typically, smoothing transitions ensures that the facial movements of the AI avatar 102, particularly lip synchronization and expressions, closely mimic the natural dynamics of human speech, avoiding any robotic or jarring transitions that could disrupt the sense of immersion for the user. When the AI avatar 102 speaks, its facial animation is driven by a sequence of blendshapes 114 corresponding to the visemes 112 of the speech. These blendshapes 114 are applied to represent different phonemes 110 visually. However, since human facial movements are continuous and rarely involve sudden shifts, the direct application of successive blendshapes 114 without smoothing can result in abrupt transitions. For example, when transitioning from the /m/ sound, which requires fully closed lips, to the /a/ sound, which involves a wide-open mouth, the smoothing algorithm 126 calculates intermediate states between the blendshapes 114, ensuring a gradual and seamless transition that mirrors natural human articulation.

The smoothing algorithm 126 maintains blendshape 114 transitions as they mitigate sudden changes and create a continuous flow of movement. The smoothing algorithm 126 analyzes the differences between successive blendshapes 114 and generates interpolated frames that bridge the gap between them. For example, consider the AI avatar 102 responding to the user query with the phrase “What can I do for you?” Each phoneme 110 in the sentence corresponds to the visemes 112, which is then mapped to the specific blendshape 114. Without smoothing, the transition from one blendshape 114 to the next might look disjointed. However, by applying the smoothing algorithm 126, the transitions between blendshapes 114 for /w/, /e/, /t/, and so on are seamlessly integrated, resulting in a smooth progression of mouth shapes and facial expressions. In at least one embodiment, the smoothing process involves mathematical techniques that generate intermediate values or frames between two blendshapes 114. Beneficially, the smoothing algorithm 126 in the blendshape 114 transitions provides realism by eliminating abrupt changes, smoothing ensures that the movements of the AI avatar 102 closely resemble those of the human speaker. Moreover, the smoothing algorithm 126 allows smooth animations to enhance the user's sense of connection with the AI avatar 102, making interactions engaging and believable.

The smoothing algorithm 126 applied to the blendshapes 114 utilizes a Savitzky-Golay filter with adjustable parameters, allowing customization of smoothing levels based on the complexity of the input data 104 and the requirement of the animation for the AI avatar 102. The Savitzky-Golay filter operates by fitting successive subsets of data points (such as the weights or positions of the blendshapes 114) with a polynomial function, effectively smoothing abrupt transitions while preserving important details such as the sharpness of lip movements and facial expressions. The adjustable parameters, such as the window size and polynomial degree, provide flexibility to tailor the smoothing to the complexity of the input data 104. For example, animations involving rapid speech or intricate viseme 112 sequences may require finer smoothing to ensure a lifelike flow, while slower or simpler speech patterns might benefit from minimal smoothing to retain natural variations. This adaptability ensures that the AI avatar 102 maintains visual coherence across diverse scenarios, enhancing its expressiveness and engagement.

In operation 216, generating a synchronized animation 128 of the AI avatar 102, by displaying lip movements and facial expressions corresponding to the input data 104. Typically, the synchronized animation 128 ensures that the visual representations of the AI avatar 102, particularly its lip movements and facial expressions, align perfectly with the speech to be delivered. In addition to lip movements, the synchronized animation 128 includes facial expressions that correspond to the context and emotional tone of the input data 104. For example, when the AI avatar 102 delivers a statement, its expressions may include raised eyebrows, widened eyes, and a smiling mouth configuration. These expressions are dynamically applied based on contextual cues derived from the input data 104, enhancing the ability of the AI avatar 102 to convey nuanced emotions.

The blendshapes 114 for lip movements are applied precisely at the timestamp of the phonemes 110. The synchronized animation 128 ensures that the visual output of the AI avatar 102 is accurate and also contextually expressive, creating a rich and immersive user experience. Additionally, the facial expressions of the AI avatar 102 enhance the interaction. It might smile slightly to convey a friendly tone, nod gently to emphasize key points, or maintain eye contact to foster engagement. The synchronized animation 128 creates an impression of a knowledgeable and approachable assistant, improving the overall user experience. Below is the pseudo-code for generating the synchronized animation 128 for the AI avatar 102.

```
function lipSync(text, ttsVoice):
  avatar = createAvatar( )
  audio, word_with_timestamps = TTS.convertTextToSpeech(text,
ttsVoice)
  phonemes =
convertWordWithTimestampsToPhonemes(word_with_timestamps)
  visemes = mapPhonemesToVisemes(phonemes)
  blendshapes = applyVisemesToBlendshapes(visemes)
  smoothedBlendshapes = applySavitzkyGolayFilter(blendshapes)
  animatedAvatar = applyBlendshapesToAvatar(smoothedBlendshapes,
avatar)
  animatedAvatarWithVoice = applyAudioToAvatar(audio,
animatedAvatar)
  return animatedAvatarWithVoice
```

The function lipSync(text, ttsVoice) generates a lip-synced animated AI avatar 102 with synchronized speech from the given text input 106 or audio stream 108. The createAvatar( ) initializes and returns the AI avatar 102 ready for the synchronized animation 128. The TTS.convertTextToSpeech(text, ttsVoice) converts the text input 106 into speech and generates word-level timestamps using the TTS module 116. The convertWordWithTimestampsToPhonemes(word_with_timestamps) translates the timestamped words into the sequence of phonemes 110 for precise speech representation. The mapPhonemesToVisemes(phonemes) maps each phoneme 110 to the corresponding viseme 112, representing the associated mouth shapes for the synchronized animation 128. The applyVisemesToBlendshapes(visemes) converts the visemes 112 into the sequence of blendshapes 114 that define the facial configurations of the AI avatar 102 for speech. The applySavitzkyGolayFilter(blendshapes) function smoothens the sequence of blendshapes 114 using the Savitzky-Golay filter to ensure natural transitions in the synchronized animation 128. The applyBlendshapesToAvatar(smoothedBlendshapes, avatar) function applies the smoothed blendshapes 114 to the AI avatar 102, creating the synchronized animation 128. The applyAudioToAvatar(audio, animatedAvatar) function integrates the generated audio stream 108 with the AI avatar 102 to produce the complete lip-synchronized output. The return animatedAvatarWithVoice function returns the AI avatar 102 with synchronized audio for use or display.

The generation of the realistic lip synchronization for the AI avatar 102 supports real-time processing of the input data 104 to generate lip-synchronized animations with minimal latency for live interactions. This ensures that as the AI avatar 102 receives and processes audio stream 108 or text input 106, the corresponding synchronized animation 128 for lip movements are generated and displayed almost instantaneously, maintaining a natural conversational flow.

For example, the sentence: “Science is important!” the timestamp for each letter is generated:
Character: ‘S’, Start: 0.000, End: 0.104
Character: ‘c’, Start: 0.104, End: 0.197
Character: ‘i’, Start: 0.197, End: 0.313
Character: ‘e’, Start: 0.313, End: 0.383
Character: ‘n’, Start: 0.383, End: 0.430
Character: ‘c’, Start: 0.430, End: 0.476
Character: ‘e’, Start: 0.476, End: 0.511
Character: ‘ ’, Start: 0.511, End: 0.557
Character: ‘i’, Start: 0.557, End: 0.604
Character: ‘s’, Start: 0.604, End: 0.639
Character: ‘ ’, Start: 0.639, End: 0.697
Character: ‘i’, Start: 0.697, End: 0.743
Character: ‘m’, Start: 0.743, End: 0.801
Character: ‘p’, Start: 0.801, End: 0.871
Character: ‘o’, Start: 0.871, End: 0.952
Character: ‘r’, Start: 0.952, End: 1.010
Character: ‘t’, Start: 1.010, End: 1.080
Character: ‘a’, Start: 1.080, End: 1.126
Character: ‘n’, Start: 1.126, End: 1.161
Character: ‘t’, Start: 1.161, End: 1.219
Character: ‘!’, Start: 1.219, End: 1.300

For each word, the start and end timestamps is calculated:
Word: ‘Science’, Start: 0.000, End: 0.511
Word: ‘is’, Start: 0.557, End: 0.639
Word: ‘important’, Start: 0.697, End: 1.219

For each word, the set of phonemes 110 are align with the word timestamps:
Word: Science
Phoneme: S, Start: 0.000, End: 0.102
Phoneme: AY1, Start: 0.102, End: 0.204
Phoneme: AH0, Start: 0.204, End: 0.307
Phoneme: N, Start: 0.307, End: 0.409
Phoneme: S, Start: 0.409, End: 0.511
Word: is
Phoneme: IH1, Start: 0.557, End: 0.598
Phoneme: Z, Start: 0.598, End: 0.639
Word: important
Phoneme: IH0, Start: 0.697, End: 0.755
Phoneme: M, Start: 0.755, End: 0.813
Phoneme: P, Start: 0.813, End: 0.871
Phoneme: AO1, Start: 0.871, End: 0.929
Phoneme: R, Start: 0.929, End: 0.987
Phoneme: T, Start: 0.987, End: 1.045
Phoneme: AH0, Start: 1.045, End: 1.103
Phoneme: N, Start: 1.103, End: 1.161
Phoneme: T, Start: 1.161, End: 1.219

Each phoneme is mapped to visemes 110:
Word: Science
Phoneme: S, Viseme: 15
Phoneme: AY1, Viseme: 11
Phoneme: AH0, Viseme: 1
Phoneme: N, Viseme: 19
Phoneme: S, Viseme: 15
Word: is
Phoneme: IH1, Viseme: 6
Phoneme: Z, Viseme: 15
Word: important
Phoneme: IH0, Viseme: 6
Phoneme: M, Viseme: 21
Phoneme: P, Viseme: 21
Phoneme: AO1, Viseme: 3
Phoneme: R, Viseme: 13
Phoneme: T, Viseme: 19
Phoneme: AH0, Viseme: 1
Phoneme: N, Viseme: 19
Phoneme: T, Viseme: 19

Below table depicts each character of the exemplary sentence with the corresponding phoneme code and viseme code:

| Time (s) | Character | Phoneme code | Viseme Index |
|---|---|---|---|
| 0.000-0.104 | S | S | 15 |
| 0.104-0.197 | c | AY1 | 11 |
| 0.197-0.313 | i | AH0 | 1 |
| 0.313-0.383 | e | N | 19 |
| 0.383-0.430 | n | S | 15 |
| 0.430-0.476 | c | — | — |
| 0.476-0.511 | e | — | — |
| 0.511-0.557 | | — | — |
| 0.557-0.604 | i | IH1 | 6 |
| 0.604-0.639 | s | Z | 15 |
| 0.639-0.697 | | — | — |
| 0.697-0.743 | i | IH0 | 6 |
| 0.743-0.801 | m | M | 21 |
| 0.801-0.871 | p | P | 21 |
| 0.871-0.952 | o | AO1 | 3 |
| 0.952-1.010 | r | R | 13 |
| 1.010-1.080 | t | T | 19 |
| 1.080-1.126 | a | AH0 | 1 |
| 1.126-1.161 | n | N | 19 |
| 1.161-1.219 | t | T | 19 |
| 1.219-1.300 | ! | — | — |

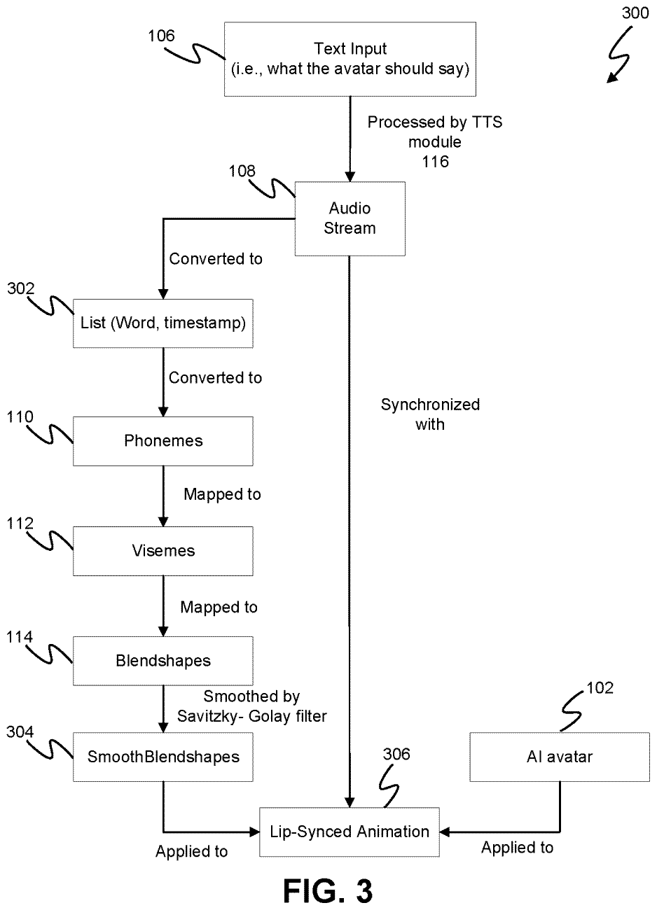

FIG. 3 depicts a realistic animation process 300 for the AI avatar 102, which is an embodiment of the lip synchronization process 200 of FIG. 2. As shown, the text input 106, which the AI avatar 102 will speak, is processed by TTS module 116. The TTS module 116 processes the text input 106 to the audio stream 108. The audio stream 108 is converted into the list of words and their corresponding timestamp. The timestamp depicts the time it takes to speak the following word. The list 302 is converted to the respective phonemes 110 aligned with the timestamps of the words. The phonemes 110 is mapped to the visemes 112 by using the predefined phoneme to viseme mapping table 122. Then the mapped visemes 112 are mapped to the blendshapes 114 by selecting the blendshape 114 from the predefined set of facial blendshapes 124 corresponding to the viseme 112. The blendshapes 114 utilizes the Savitzky-Golay to create smoothed blendshapes 304. The smoothed blendshapes 304 is applied to lip-synched animation 306 and the audio stream 108 is also synchronized with the lip-synched animation 306. The lip-synched animation 306 is further applied to the AI avatar 102 to generate animation.

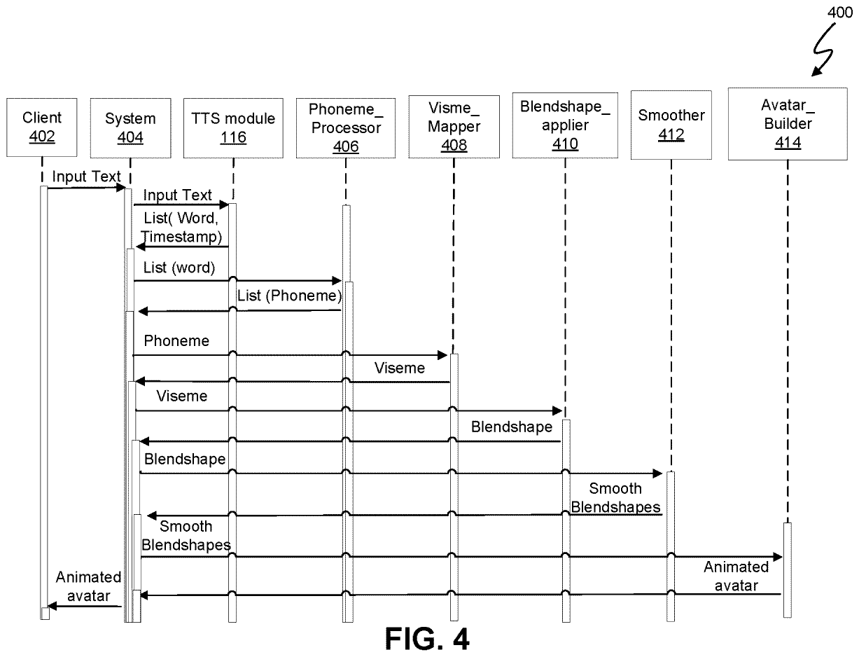

FIG. 4 depicts the sequence diagram 400 for generating the AI avatar 102, which is an embodiment of the lip synchronization process 200 of FIG. 2. As shown, a client 402 provides the text input 106 to a system 404. The system 404 is a platform where the client 404 interacts with the AI avatar 102. The client 402 is the user who is communicating with the AI avatar 102 via the system 404. The system 404 provides the text input 106 received from the client 402 to the TTS module 116. The TTS module 116 converts the text input 106 into the words and corresponding timestamps for each word and provides it back to the system 404. The system 404 provides the words to a phoneme processor 406. The phoneme processor generates the respective phonemes 110 aligned with the timestamps of the words and provides it back to the system 404. The system 404 sends the phonemes 110 to a viseme mapper 408. The viseme mapper 408 maps the phonemes 110 to the visemes 112 and provides the visemes 112 back to the system 404. Then the system 404 sends the visemes 112 to a blendshape applier 410. The blendshape applier 410 mapped the visemes 112 to the blendshapes 114 and provided the blendshapes 114 back to the system 404. The blendshapes 114 are provided to a smoother 412 by the system 404 to generate the smoothed blendshapes. The smoothed blendshapes are provided to an avatar builder 414. The avatar builder 414 utilizes the smoothed blendshapes and audio to generate the animated AI avatar 102. The generated AI avatar is then provided to the client 402 through the system 404.

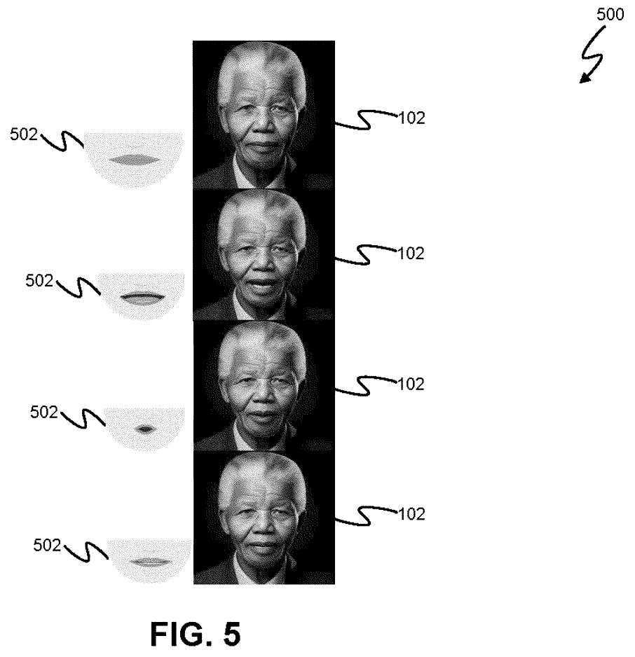

FIG. 5 depict exemplary representation 500 showing viseme visual representations and respective images of the AI avatar 102. The visual representations 502 and the AI avatar 102 are shown having same lip movement. The visual representation 502 depicts how the AI avatar 102 lips move when speaking to a specific character in the sentence. The viseme visual representations 502 are converted into the blendshapes indexes. The blendshapes indexes are indexes of an image that represents specific blendshape 114. The blendshapes 114 are smoothened to create a smooth transition of the AI avatar 102.

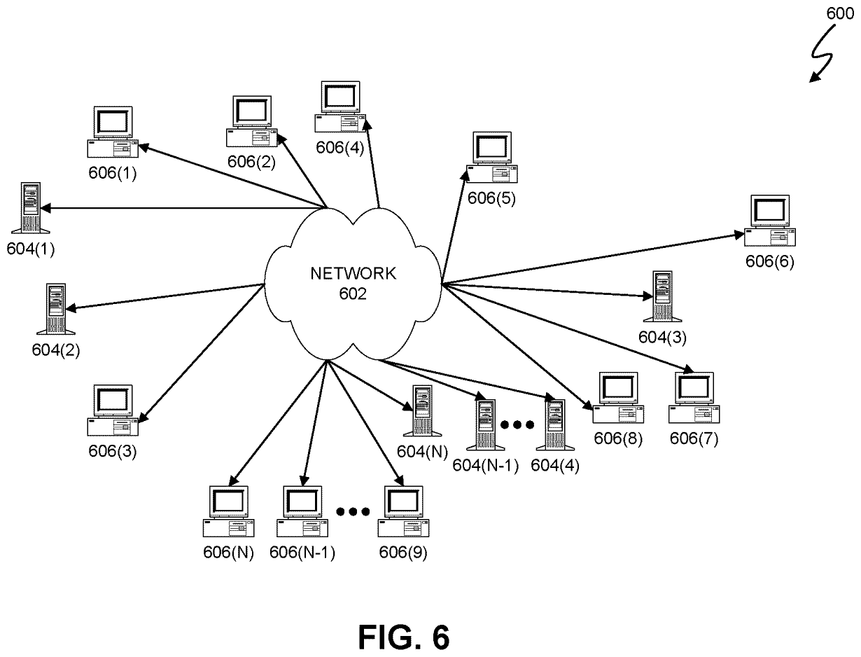

FIG. 6 is a block diagram illustrating a network environment in which a lip synchronization system 100 and lip synchronization process 200 may be practiced. Network 602 (e.g. a private wide area network (WAN) or the Internet) includes a number of networked server computer systems 604(1)-(N) that are accessible by client computer systems 606(1)-(N), where N is the number of server computer systems connected to the network. Communication between client computer systems 606(1)-(N) and server computer systems 604(1)-(N) typically occurs over a network, such as a public switched telephone network over asynchronous digital subscriber line (ADSL) telephone lines or high-bandwidth trunks, for example communications channels providing T1 or OC3 service. Client computer systems 606(1)-(N) typically access server computer systems 604(1)-(N) through a service provider, such as an internet service provider (“ISP”) by executing application specific software, commonly referred to as a browser, on one of client computer systems 606(1)-(N).

Client computer systems 606(1)-(N) and/or server computer systems 604(1)-(N) are specialized computer programmed to improve conventional computer systems to implement and utilize the lip synchronization system 100 and lip synchronization process 200. The type of computer system that can be specially programmed to implement and utilize the lip synchronization system 100 and lip synchronization process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the lip synchronization system 100 and lip synchronization process 200 can be implemented using code stored in a tangible, non-transient computer readable medium and executed by one or more processors. In at least one embodiment, the lip synchronization system 100 and lip synchronization process 200 can be implemented completely in hardware using, for example, logic circuits and other circuits including field programmable gate arrays.

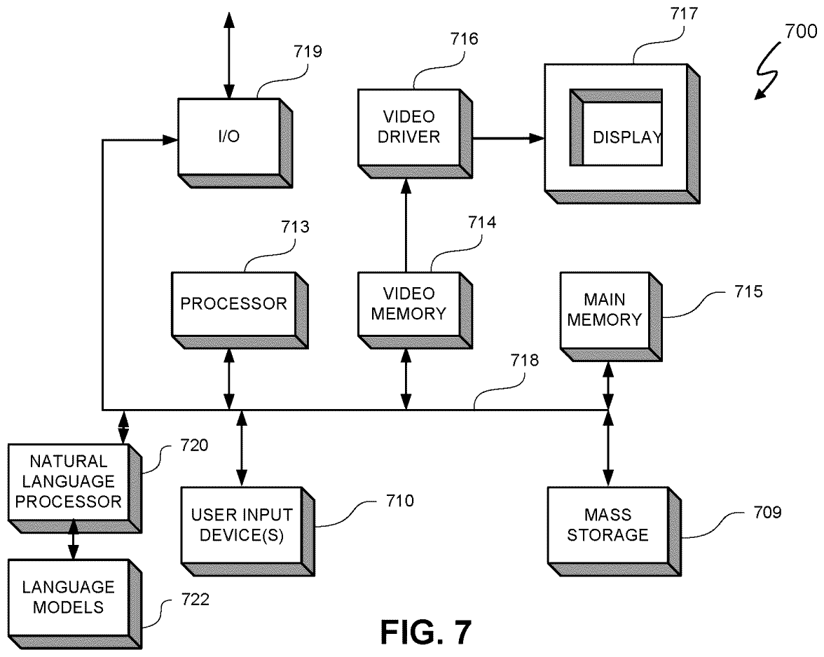

Embodiments of the lip synchronization system 100 and lip synchronization process 200 can be implemented on a computer system such as a special-purpose, special-programmed computer 700 illustrated in FIG. 7. Input user device(s) 710, such as a keyboard and/or mouse, are coupled to a bi-directional system bus 718. The input user device(s) 710 are for introducing user input to the computer system and communicating that user input to processor 713. The computer system of FIG. 7 generally also includes a non-transitory video memory 714, non-transitory main memory 715, and non-transitory mass storage 709, all coupled to bi-directional system bus 718 along with input user device(s) 710 and processor 713. The mass storage 709 may include both fixed and removable media, such as a hard drive, one or more CDs or DVDs, solid state memory including flash memory, and other available mass storage technology. Bus 718 may contain, for example, 32 of 64 address lines for addressing video memory 714 or main memory 715. The system bus 718 also includes, for example, an n-bit data bus for transferring DATA between and among the components, such as CPU 709, main memory 715, video memory 714 and mass storage 709, where “n” is, for example, 32 or 64. Alternatively, multiplex data/address lines may be used instead of separate data and address lines.

I/O device(s) 719 may provide connections to peripheral devices, such as a printer, and may also provide a direct connection to a remote server computer systems via a telephone link or to the Internet via an ISP. I/O device(s) 719 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 709, into main memory 715 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 713, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 715 is comprised of dynamic random access memory (DRAM). Video memory 714 is a dual-ported video random access memory. One port of the video memory 714 is coupled to video amplifier 716. The video amplifier 716 is used to drive the display 717. Video amplifier 716 is well known in the art and may be implemented by any suitable means. This circuitry converts pixel DATA stored in video memory 714 to a raster signal suitable for use by display 717. Display 717 is a type of monitor suitable for displaying graphic images.

The computer system described above is for purposes of example only. The lip synchronization system 100 and lip synchronization process 200 may be implemented in any type of computer system or programming or processing environment. It is contemplated that the lip synchronization system 100 and lip synchronization process 200 might be run on a stand-alone computer system, such as the one described above. The lip synchronization system 100 and lip synchronization process 200 might also be run from a server computer systems system that can be accessed by a plurality of client computer systems interconnected over an intranet network. Finally, the lip synchronization system 100 and lip synchronization process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for generating realistic lip synchronization for an AI avatar, comprising:
receiving input data, wherein the input data includes a text input that specifies the content, or an audio stream containing spoken content to be spoken by the AI avatar;
processing the input data, wherein
if the input data includes the text input, using a text-to-speech (TTS) module to convert the text input into speech and generate word-level timestamps corresponding to the pronunciation of each word of the text input, and
if the input data includes the audio stream, applying an automatic speech recognition (ASR) module to transcribe the spoken content of the 12 audio stream into text and generate word-level timestamps indicating when each word occurs within the audio stream;
extracting phonemes using a grapheme-to-phoneme conversion system to transform the transcribed text into a sequence of phonemes, wherein the grapheme-to-phoneme conversion system preserves the indexing of the phonemes relative to their positions within the input data;
mapping the phonemes to visemes to determine a viseme corresponding to each phoneme using a predefined phoneme to viseme mapping table, wherein the phonemes share similar mouth shapes are assigned to the same viseme;
mapping the visemes to blendshape of the AI avatar by selecting the blendshape from a predefined set of facial blendshapes corresponding to the viseme, wherein the selection of the blendshape is based on an image similarity comparison between visual reference of the viseme representing the mouth shape of a human associated with the phoneme, and associating each viseme with the blendshape that exhibits the closest visual similarity to the image of the AI avatar;
animating the AI avatar by applying the selected blendshapes to the images to generate a sequence of animations that corresponds to the viseme sequence derived from the input data and ensuring that the animation is synchronized;
smoothing transitions between the successive blendshapes by applying a smoothing algorithm to reduce abrupt changes between the blendshapes to allow a natural flow of the lip movements and facial expressions of the AI avatar; and
generating a synchronized animation of the AI avatar displaying lip movements and facial expressions corresponding to the input data.

2. The method of claim 1 wherein the TTS module provides multiple voice and speech style options, including pitch, speed, tone, and accent.

3. The method of claim 1 wherein the audio stream processed through the ASR module supports multi-language transcription to dynamically select the appropriate language based on the characteristics of the AI avatar.

4. The method of claim 1 wherein the grapheme-to-phoneme conversion system employs a rule-based, index-preserving transformation technique that ensures accurate extraction of phonemes for complex text inputs, including numerical values, abbreviations, and special symbols.

5. The method of claim 1 wherein the viseme to the blendshape mapping utilizes a machine learning algorithm that is trained on a dataset of human facial expressions to improve the accuracy of the viseme to the blendshape associations.

6. The method of claim 1 further comprises:
interpolating between the consecutive blendshapes using an interpolation technique to enhance the smoothness of animations during speech transitions.

7. The method of claim 1 wherein the smoothing algorithm applied to the blendshapes utilizes a Savitzky-Golay filter with adjustable parameters, allowing customization of smoothing levels based on the complexity of the input data and requirement of the animation for the AI avatar.

8. The method of claim 1 wherein the generation of the realistic lip synchronization for the AI avatar supports real-time processing of the input data to generate lip-synced animations with minimal latency for live interactions.

9. A system for generating realistic lip synchronization for an AI avatar, comprising:
receiving input data, wherein the input data includes a text input that specifies the content, or an audio stream containing spoken content to be spoken by the AI avatar;
processing the input data, wherein
if the input data includes the text input, using a text-to-speech (TTS) module to convert the text input into speech and generate word-level timestamps corresponding to the pronunciation of each word of the text input, and
if the input data includes the audio stream, applying an automatic speech recognition (ASR) module to transcribe the spoken content of the audio stream into text and generate word-level timestamps indicating when each word occurs within the audio stream;
extracting phonemes using a grapheme-to-phoneme conversion system to transform the transcribed text into a sequence of phonemes, wherein the grapheme-to-phoneme conversion system preserves the indexing of the phonemes relative to their positions within the input data;
mapping the phonemes to visemes to determine a viseme corresponding to each phoneme using a predefined phoneme to viseme mapping table, wherein the phonemes share similar mouth shapes are assigned to the same viseme;
mapping the visemes to blendshape of the AI avatar by selecting the blendshape from a predefined set of facial blendshapes corresponding to the viseme, wherein the selection of the blendshape is based on an image similarity comparison between visual reference of the viseme representing the mouth shape of a human associated with the phoneme, and associating each viseme with the blendshape that exhibits the closest visual similarity to the image of the AI avatar;
animating the AI avatar by applying the selected blendshapes to the images to generate a sequence of animations that corresponds to the viseme sequence derived from the input data and ensuring that the animation is synchronized;
smoothing transitions between the successive blendshapes by applying a smoothing algorithm to reduce abrupt changes between the blendshapes to allow a natural flow of the lip movements and facial expressions of the AI avatar; and
generating a synchronized animation of the AI avatar displaying lip movements and facial expressions corresponding to the input data.

10. The system of claim 9 wherein the TTS module provides multiple voice and speech style options, including pitch, speed, tone, and accent.

11. The system of claim 9 wherein the audio stream processed through the ASR module supports multi-language transcription to dynamically select the appropriate language based on the characteristics of the AI avatar.

12. The system of claim 9 wherein the grapheme-to-phoneme conversion system employs a rule-based, index-preserving transformation technique that ensure accurate extraction of phonemes for complex text inputs, including numerical values, abbreviations, and special symbols.

13. The system of claim 9 wherein the viseme to the blendshape mapping utilizes a machine learning algorithm that is trained on a dataset of human facial expressions to improve the accuracy of the viseme to the blendshape associations.

14. The system of claim 9 further comprises:
interpolating between the consecutive blendshapes using an interpolation technique to enhance the smoothness of animations during speech transitions.

15. The system of claim 9 wherein the smoothing algorithm applied to the blendshapes utilizes a Savitzky-Golay filter with adjustable parameters, allowing customization of smoothing levels based on the complexity of the input data and requirement of the animation for the AI avatar.

16. The system of claim 9 wherein the generation of the realistic lip synchronization for the AI avatar supports real-time processing of the input data to generate lip-synced animations with minimal latency for live interactions.
